(19) United States
(12) Patent Application Publication
(10) Pub. No.: US 2015/0193852 A1
(43) Pub. Date: Jul. 9, 2015

(54) SYSTEM AND METHOD FOR MULTI-USER EVALUATION OF HEALTHPLAN BENEFIT BASED ON PRESCRIPTION COVERAGE ANNUAL COST

(71) Applicant: CGI Federal, Inc., Fairfax, VA (US)

(72) Inventors: Steven Bettencourt Sousa, Washington, DC (US); Ksheeraja Nandakumar Velangulam, Ashburn, VA (US); Sawrab Nayak, Fairfax, VA (US)

(73) Assignee: CGI FEDERAL, INC., Fairfax, VA (US)

(21) Appl. No.: 14/593,412

(22) Filed: Jan. 9, 2015

Related U.S. Application Data
(60) Provisional application No. 61/925,506, filed on Jan. 9, 2014.

(51) Int. Cl. G06Q 30/06; G06F 17/30

(52) U.S. Cl. CPC G06Q 30/0629; G06F 17/30554

(57) ABSTRACT

A system and method for displaying health plans to consumers is provided. The system and method can be accessed directly by consumers or other entities can help consumers by providing information needed to make a decision. For example a pharmacy can implement the system within their environment where patient drug profile is easily accessible to find the best plan for the member as a service. A user can search for a health plan based on input criteria such as their ZIP Code and their choice of drugs. Based on the input criteria, the method displays the most cost effective health plans with the least annual drug costs for available pharmacies.

### FIELD OF THE INVENTION

The present disclosure relates generally to computer systems and processes for collecting information from a user that may be used for the purposes of evaluating health plan benefits.

### BACKGROUND OF THE INVENTION

Consumers face challenges in the field of health such as making informed decisions and reducing healthcare costs. Plan sponsors and the Government also face challenges in reducing costs and streamlining the current business process. Because of the expense of medications, it is in the interest of patients to be able to find the most cost effective health plans with the least annual drug costs.

Numerous factors enter into the determination of what is optimum for each individual patient when choosing health plans or obtaining his or her medications. A patient may consider, for instance, how far he or she must travel to different local retail pharmacies, the time difference involved in patronizing a local retail pharmacy as compared to obtaining medications from a mail-order pharmacy, and/or a Preferred Network Pharmacy for a lower cost. For example, a patient may accept the need for longer travel time to a more distant pharmacy if that pharmacy's price for the medication is lower than the price at a pharmacy which is more conveniently located.

Oftentimes a patient cannot readily determine what prices are being charged for a particular medication at different pharmacies. A patient could theoretically shop several different pharmacies, either by traveling to each or telephoning each, to determine which provides the best combination of price and convenience. However, this is not time-feasible for many patients. Thus, a patient usually ends up simply obtaining his or her medications from a pharmacy recommended to the patient, or by referring to some self-interested source such as a pharmacy's newspaper advertisement, without having means to recognize that another pharmacy (or perhaps several other pharmacies) convenient to the patient has the same medication available at a substantially lower cost. The cost of medication plays very crucial role in drug plan benefit specifically for Medicare Part D. The high cost of drug can put a member in GAP or Donut hole of Medicare Part D benefit where member pays the full cost of the drugs.

What is needed is a multi-user web portal providing choices of health plans, pharmacies and locations, choice of doctors and hospitals, choices of brand and generic drugs, choices of co-payment and out of pocket pricing options, choices of fulfillment options, and relevant safety, health and wellness information.

### SUMMARY OF THE INVENTION

The present disclosure is a system and method for displaying health plans to consumers. The system and method can be accessed directly by consumers or other entities can help consumers by providing information needed to make a decision. For example a pharmacy can implement the system within their environment where patient drug profile is easily accessible to find the best plan for the member as a service. A user can search for a health plan based on input criteria such as their ZIP Code and their choice of drugs. Based on the input criteria, the method displays the most cost effective health plans with the least annual drug costs for available pharmacies. The method displays the cost of the drugs at other pharmacies for a plan. The method also allows users to select a pharmacy of their choice within a plan and find the most cost effective plan where the selected pharmacy is preferred. The method allows users to see the detailed formulary information of the drugs selected including formulary tier status, quantity limit including the amount allowed per day, prior authorization requirements including the detailed information, step therapy requirements and the limited access requirement.

The present disclosure allows users to see the most cost effective health plans offered in the area of their residence by calculating selected drug costs. The present disclosure shows the health plans with the most cost-effective pharmacy per plan and allows users to see the cost differences between pharmacies available nearby.

One embodiment of the present disclosure includes an intuitive user interface (UI) that allows users to follow simple steps to get find the most cost effective health plans with the least annual drug costs. The smart menu allows user to add, delete or modify drugs or change zip-code on the fly without going all the back to the drug selection page.

One embodiment of the present disclosure is implemented using service oriented architecture (SOA). The SOA software design is based on discrete pieces of software providing application functionality as services to other applications. The SOA allows each service to integrate with existing applications in a seamless manner, for example the drug search component of the tool could be a service itself and could be easily implemented into any web based application.

### BRIEF DESCRIPTION OF THE DRAWINGS

FIG. 1 shows a screen shot of an exemplary “Start Page” page of the present invention.

FIG. 2 shows a screen shot of an exemplary “Add Drug” page of the present invention.

FIG. 3 shows a screen shot of an exemplary “Find Your Drug” page of the present invention.

FIG. 4 shows a screen shot of an exemplary “Brand/Generic Popup” page of the present invention.

FIG. 5 shows a screen shot of an exemplary “Selected Drugs Page” page of the present invention.

FIG. 6 shows a screen shot of an exemplary “Enter Zip Page” page of the present invention.

FIG. 7 shows a screen shot of an exemplary “Plans Result Page” page of the present invention.

FIG. 8 shows a screen shot of an exemplary “Smart Update” page of the present invention.

FIG. 9 shows a screen shot of an exemplary “Map View” page of the present invention.

FIG. 10 shows a screen shot of an exemplary “Map View: Provider Selection Popup” page of the present invention.

FIG. 11 shows a screen shot of an exemplary “Plan Detail View” page of the present invention.

FIG. 12 shows a screen shot of an exemplary “Plan Detail View: In-Network Search” page of the present invention.

FIG. 13 shows a screen shot of an exemplary “Plan Compare” page of the present invention.

FIG. 14 shows a screen shot of an exemplary “Plan Compare: Close-Up View” page of the present invention.

FIG. 15 shows a screen shot of an exemplary “Annual Cost and Benefit Coverage Phase Graph” page of the present invention.

FIG. 16 is a user flow diagram according to an embodiment of the present disclosure.

FIG. 17 is an application high level overview of an embodiment of the present disclosure, including users, services, business, and data layer.

FIG. 18 is an application high level overview of an embodiment of the present disclosure, including users, services, business, and data layer.

FIG. 19 is the different architectural layers of the application according to an embodiment of the present disclosure.

FIGS. 20A and 20B depict the possible actions the user can take to get from opening the web application to enrolling in a plan.

Appendix A illustrates exemplary services that could be utilized in the performance of present disclosure.

Appendix B is pseudo code for various functions used within the present disclosure.

### DETAILED DESCRIPTION

The following detailed description discloses various embodiments and features of the present disclosure. These embodiments and features are meant to be exemplary and not limiting. Accordingly, those of ordinary skill in the art will recognize that various changes and modifications of the embodiments described herein can be made without departing from the scope and spirit of the invention.

The present disclosure is a system and method for displaying health plans to a consumer. A user can search for a health plan based on input criteria such as their ZIP Code or other geographical information and drugs (brand name or generic). Based on the input criteria, the method displays the most cost effective health plans with the least annual drug costs for available pharmacies.

The present disclosure allows users to see the most cost effective health plans offered in the area of their residence by calculating selected drug costs. The present disclosure shows the health plans with the most cost-effective pharmacy and allows users to see the cost differences between pharmacies available nearby and within a specific zip code. It can be appreciated that embodiments of the present disclosure maximize use of publically available data, for example National Plan and Provider Enumeration System (NPPES) data for National Provider Identification (NPI) information for pharmacy demographics. Embodiments of the present disclosure update formulary, pricing and plan information as frequently as needed, near real-time information available to users.

In one embodiment, a pharmacy can also implement this tool to help customers identify the most cost effective plan. A drugstore chain may integrate with their pharmacy software that will allow the drugstore chain to pull the list of the drugs taken from the patient profile and then look for most cost effective plan for them.

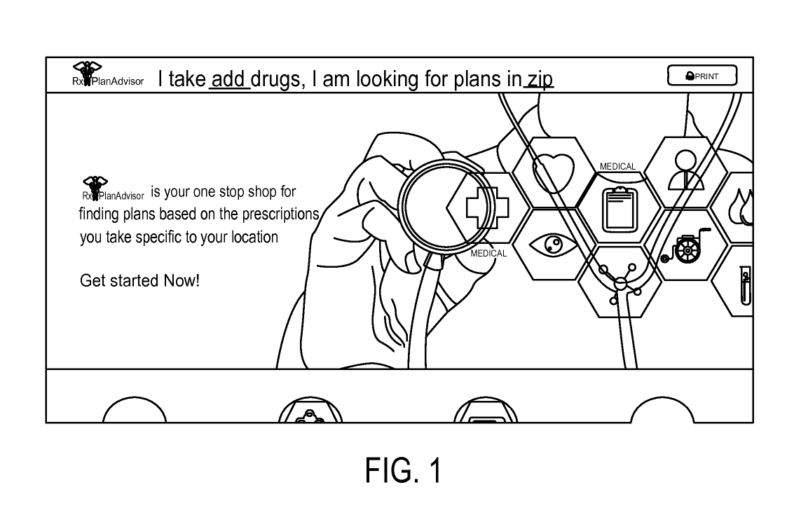

FIG. 1 shows a screen shot of an exemplary “Start Page” page of the present invention. The Start page provides information and specifies how this application can solve most of the issues face by health plans and Centers for Medicare and Medicaid (MS) in providing appropriate plans for members to compare and enroll. The Start page allows users to start the process of finding plans by selecting “add drugs” or by selecting “get started now”. “add drugs” or “get started now” takes a user to the drug page to add drug information. Various embodiments of the present disclosure allow this tool to work in smart phones and tablets as well.

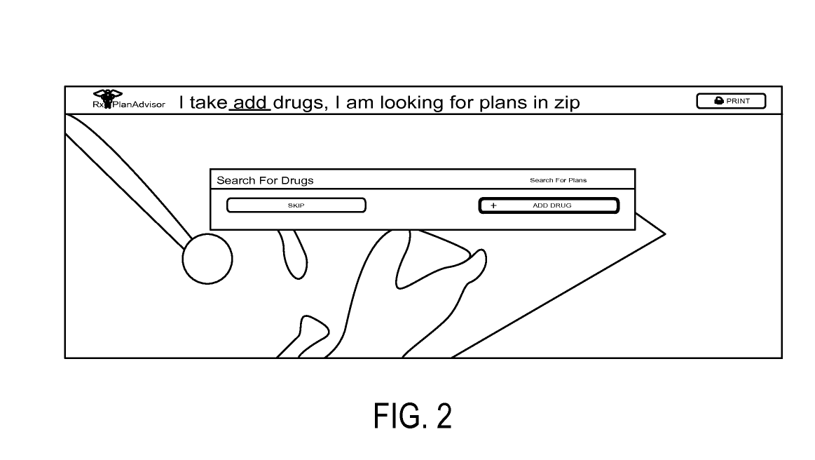

FIG. 2 shows a screen shot of an exemplary “Add Drug” page of the present invention. This page allows users to add a drug or skip if they are not taking any drugs. Skip will take users directly to the zip page where user can input the zip code they reside in to get the cost effective plans without drugs. Add Drugs will open the drug search form.

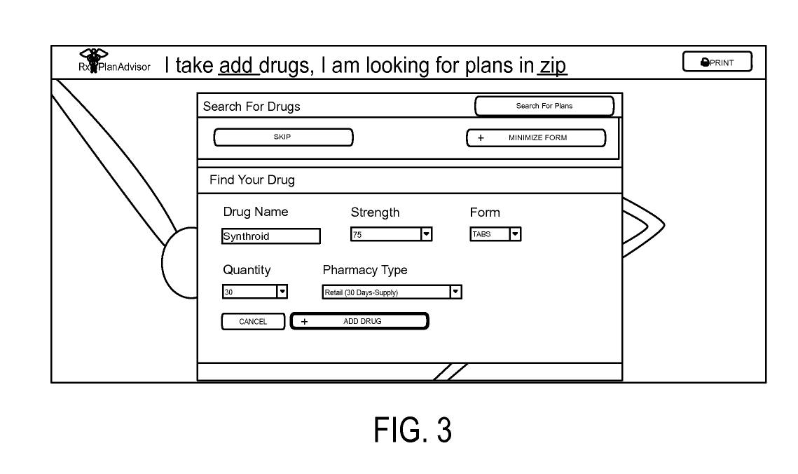

FIG. 3 shows a screen shot of an exemplary “Find Your Drug” page of the present invention. This page allows users to search for drugs and select the strength, form quantity and retail/mail pharmacy with days' supply. For each unique drug, system reflects a 30 days' supply recommended usual daily dose for geriatric population assuming the user is searching for a Medicare Managed Care Plan.

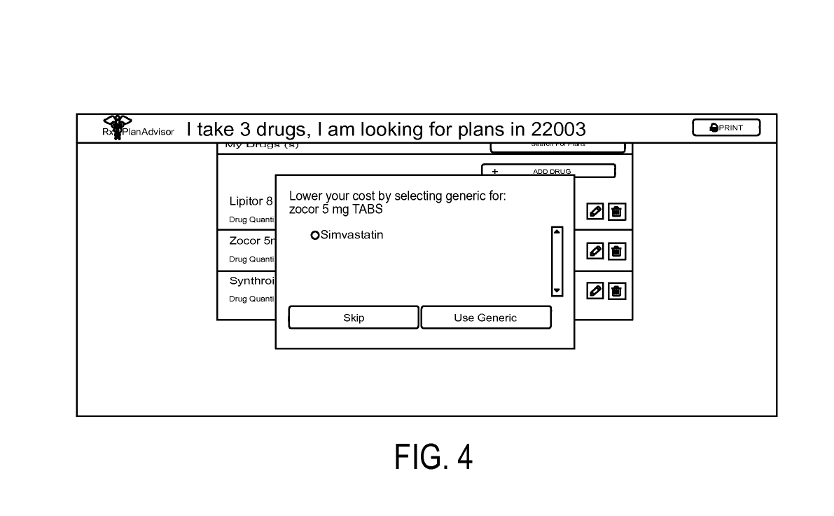

FIG. 4 shows a screen shot of an exemplary “Brand/Generic Popup” page of the present invention. When user selects “Add Drug” in the “Find Your Drug” screen, this pop shows up based on if the drug is generically available. It can be appreciated that this feature allows users to choose a generic drug for lower cost or to keep the brand name drug. Generic alternatives for selected drugs can result in reduced annual drug costs.

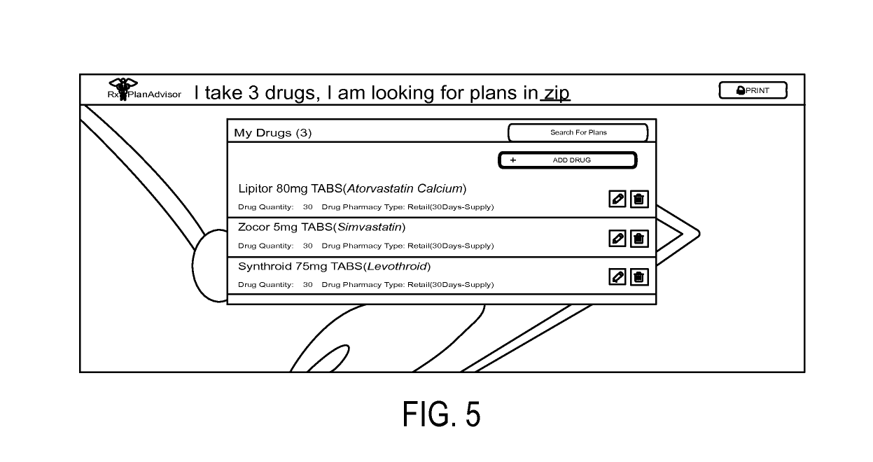

FIG. 5 shows a screen shot of an exemplary “Selected Drugs Page” page of the present invention. This page shows the selected drugs and allows users to modify or remove drugs from the list to find plans. This page also lists the number of drugs in the cart and allows users to modify and remove drugs from the list.

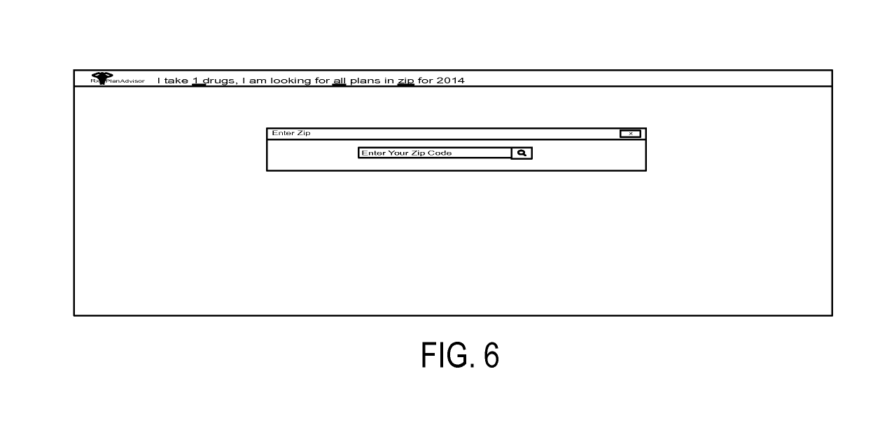

FIG. 6 shows a screen shot of an exemplary “Enter Zip Page” page of the present invention. This page requires users to insert zip-code they reside in. If a zip-code splits into two counties then user will have to select a county.

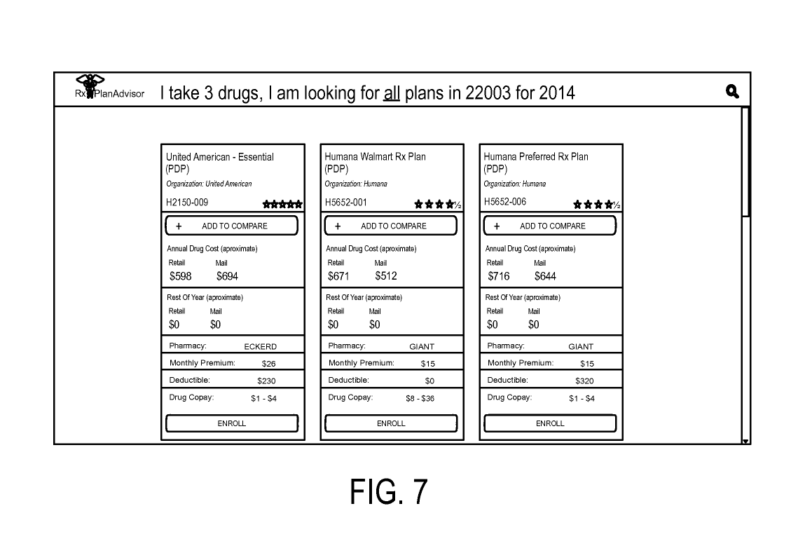

FIG. 7 shows a screen shot of an exemplary “Plans Result Page” page of the present invention. In this page, plans are shown sorted based on annual drug cost. Users have the option to change the sorting in this page. User can also filter plans by choice of provider (pharmacy, Doctor or hospital network). Select any plan to see the details and search network, see formulary status of drugs, star ratings that reflects the different quality measure metrics evaluated by CMS etc. The Map View allows user to see all the providers in MAP and select the plans based on a specific provider. Embodiments of the present disclosure work in smart phones and tablets.

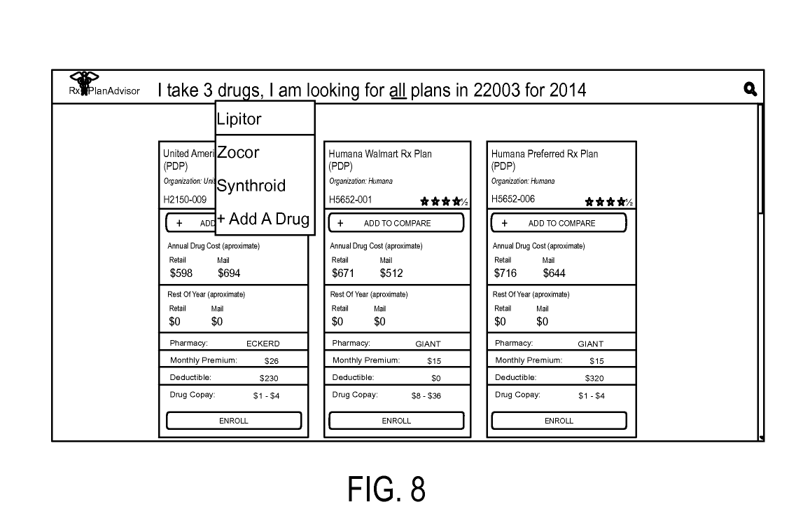

FIG. 8 shows a screen shot of an exemplary “Smart Update” page of the present invention. Users can add, modify and remove drugs form any page by selecting the top number. If a user selects the top number, then a drop down appears showing all of the selected drugs. The drop down also allows a user to add a drug. User can also change the zip-code and plan year by selecting the values in smart menu.

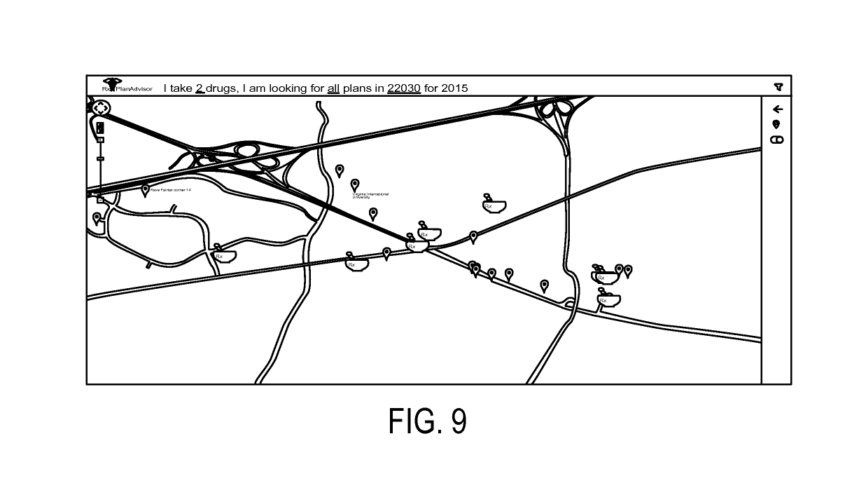

FIG. 9 shows a screen shot of an exemplary “Map View” page of the present invention. The map view plots out the entire provider locations on a map that the user can choose from based on their selection of drugs and the zip code in which they live. The user can then interact with these and view further information such as that providers; location, telephone number and address.

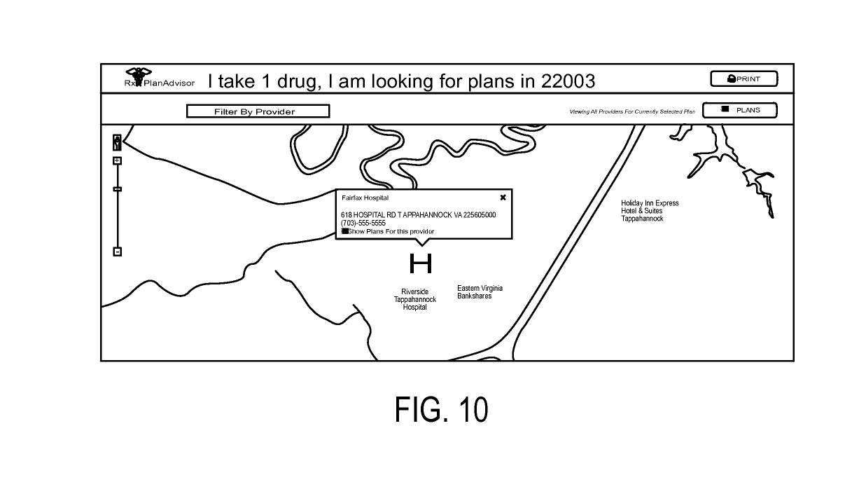

FIG. 10 shows a screen shot of an exemplary “Map View: Provider Selection Popup” page of the present invention. User can select the provider here and see all the plans, where selected provider is in Network. It can be appreciated that Map View allows filtering of plans for specific providers (Doctor, Pharmacy and Hospitals) and allows filtering to quickly sort through providers (Doctor, Pharmacy and Hospitals) on a geographical view using the map. From this view the user can also see what plans are associated with the selected provider by clicking the show all plans in the pop-up.

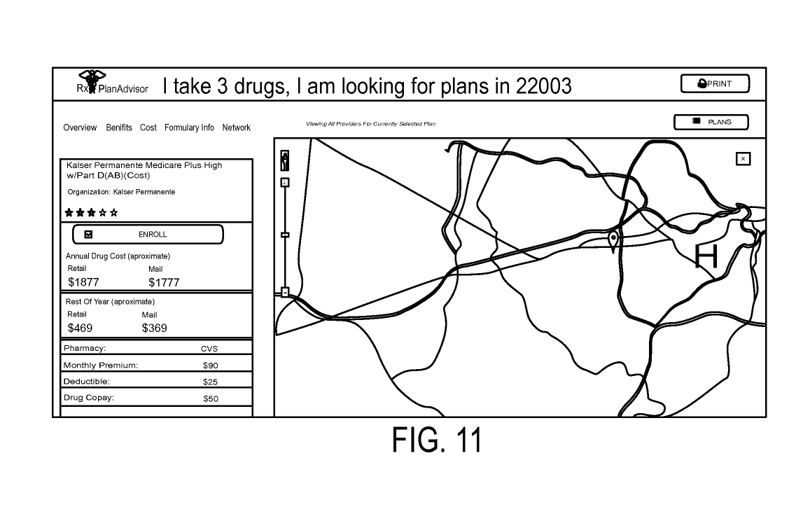

FIG. 11 shows a screen shot of an exemplary “Plan Detail View” page of the present invention. The detail view shows a single plan with additional pertinent information the user can tab between such as; benefits, cost, formulary information and network information. While in detail view the user can also see the locations of all the providers associated with the selected plan.

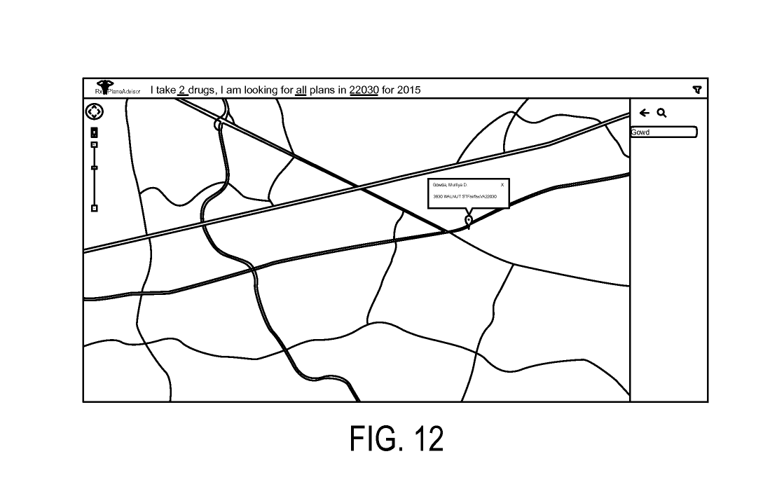

FIG. 12 shows a screen shot of an exemplary “Plan Detail View: In-Network Search” page of the present invention. Plan details allows user to search for a specific provider for example doctor and hospital to see if the provider is in network for selected plan. The provider searched if found within network, is plotted in the map.

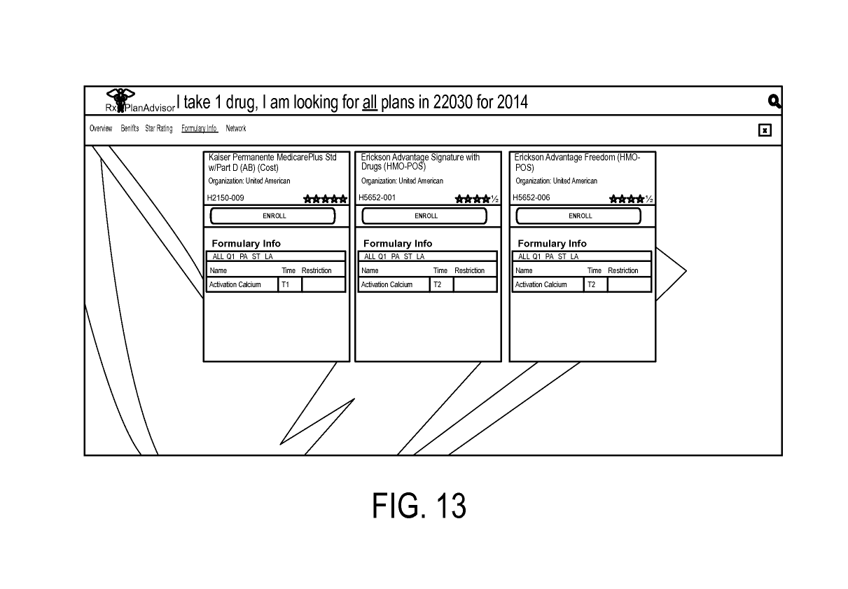

FIG. 13 shows a screen shot of an exemplary “Plan Compare” page of the present invention. Users can select up to three plans for compare. This page shows the details of the plans. The navigation below changes the details for all three plan details (shown below).

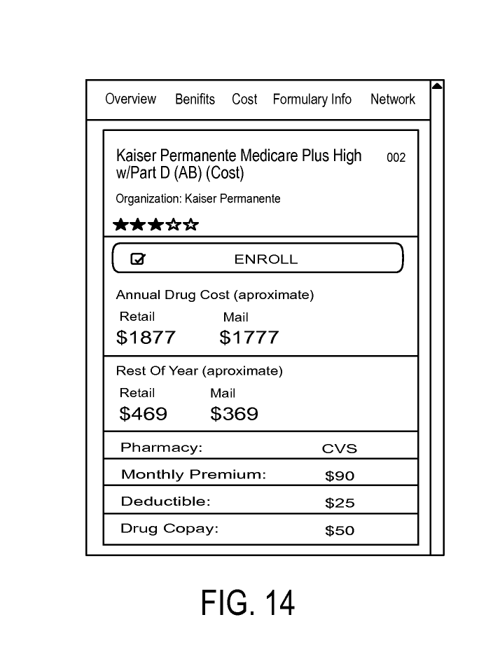

FIG. 14 shows a screen shot of an exemplary “Plan Compare: Close-Up View” page of the present invention. The navigation allows users to get to the details for plans selected either one or in compare mode for up to three plans. Details can include an overview, benefits, cost, formulary info, or network information.

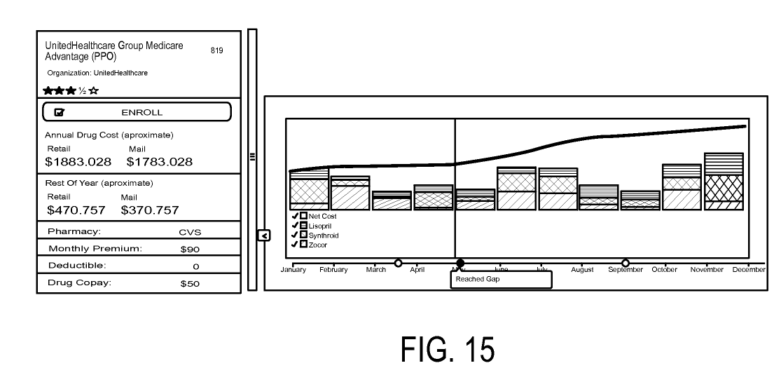

FIG. 15 shows a screen shot of an exemplary “Annual Cost and Benefit Coverage Phase Graph” page of the present invention. The interactive graph shows the net drug cost of the plan benefit per month per drug selected. The graph also shows the consumer True out of Pocket Cost (TrOOP). The interactive graph shows the user at what time and if they will enter a given level of benefit coverage. The graph includes a breakdown of each drug as well as the sum total of all of the drugs per month. In other embodiments, the graph shows the net cost per any variable of time such as quarter or week. The interactive graph utilizes the latest D3 JavaScript library to bring forth powerful and fast data driven DOM manipulations.

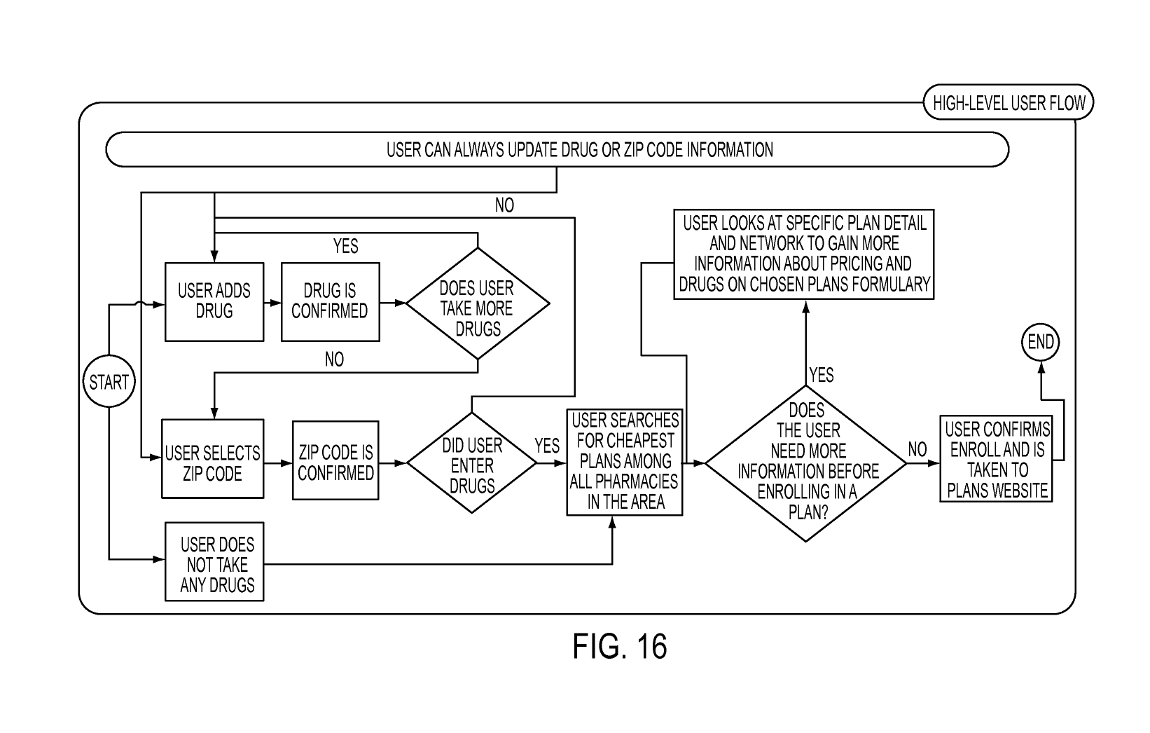

FIG. 16 is a user flow according to an embodiment of the present disclosure. First, a user can add a drug, select a zip code, or choose that they do not take any drugs. If a user adds a drug, then the drug is confirmed, and then the user is prompted whether they take more drugs. If they do, then the method returns to the add drug state. If not, then the method goes to the select a zip code state where they select the zip code in which they wish to operate. Next, the zip code is confirmed, and then the user is prompted whether they entered drugs, and the method proceeds to search for the cheapest plans among all pharmacies in the zip code area. Next, the user is prompted whether they need more information before enrolling in a plan. If yes, then the user looks at specific plan detail and network to gain more information about pricing and drugs on the chosen plans formulary. If no, then the user confirms enrollment and is taken to the plans website.

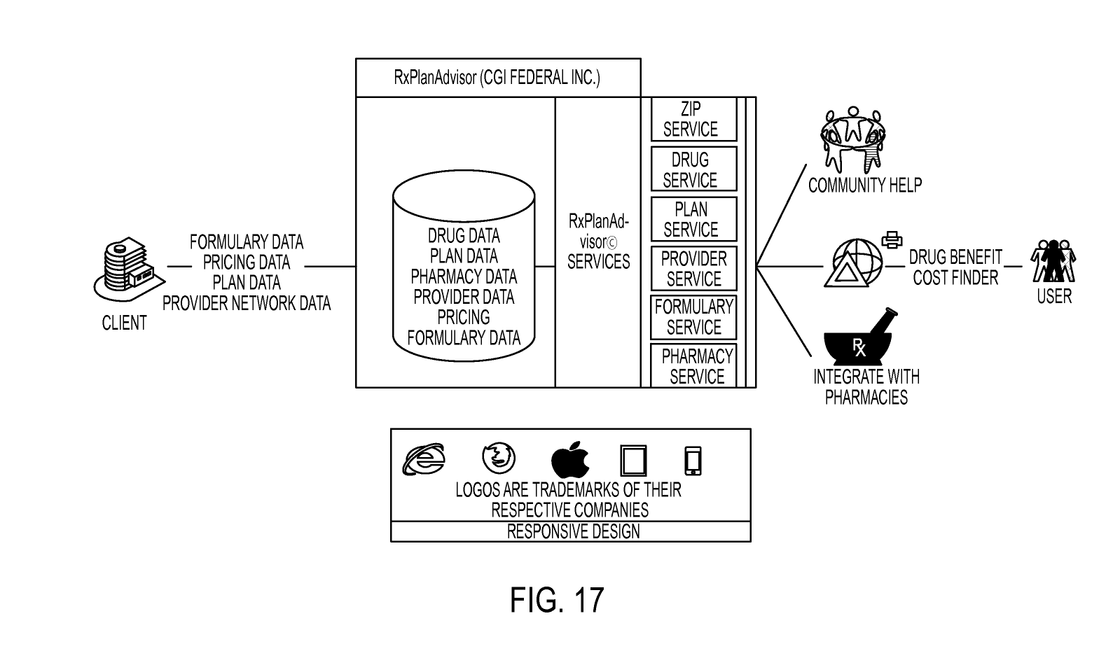

FIG. 17 is an application high level overview of an embodiment of the present disclosure, including users, services, business, and data layer. FIG. 17 demonstrates the application high level overview of an embodiment of the present disclosure, including users, services, business, and data layers. Embodiments of the present disclosure can be implemented as a stand alone product or integrated as one or more services to existing applications. One embodiment is built with a service oriented architecture, which allows the implementation of the entire package including the User Interface (UI) or only one or more services. It can be appreciated that SOA provides the flexibility to use any front-end platform and allows for easy migration from one platform to another. SOA also allows full product or service only implementation with minimal effort.

One embodiment of the present disclosure includes a calculation algorithm which uses LINQ queries to sort through plans available in the user's geographical area and for each plan perform a unique pharmacy selection method to find the best pharmacy for each. The cost of the drug per pharmacy represents the net negotiated drug cost plus the cost of dispensing the drug based on brand or generic and days supply.

In one embodiment, the unique pharmacy selection method uses LINQ queries to allow the application to quickly sort through all pharmacies in a given area and chose the cheapest one based on the combination of a users' given location and their drug selection. The unique pharmacy selection method can return not only the lowest cost pharmacy but also a list of all other pharmacies and their cost for the selected drugs for a particular plan. So the user can see a full list and make a full informed decision when choosing what plan fits their needs best.

One embodiment of the present disclosure includes a provider network search which allows the user to determine if their provider is present in any one of the plans returned by the JSON services. The user can search provider within a particular plan or the user can search globally among all returned plans to see the provider network status.

One embodiment of the present disclosure includes a quick menu that allows the user to easily add a drug change a zip or look at previously entered information with ease. This quick menu can be implemented using CSS3, HTML and jQuery.

One embodiment of the present disclosure includes a voice command tool which gives the user the option to interface with the system using their voice. Users can navigate through the web application add drugs and edit their information. The voice command tool utilizes the latest in speech recognition technology to understand the users' commands.

One embodiment of the present disclosure includes a map view which may use the Google Maps API and the jQuery library to allow the user to see all of the providers in their geographic area, allowing them to see addresses as well as plans associated with a selected provider. The map view can include a map filter which allows the user to quickly sort through providers on a geographical scale. The user can filter on the basis of provider name and chosen plan. The map filters may use a combination of the Google Maps JavaScript Application Program interface and the latest JQuery library.

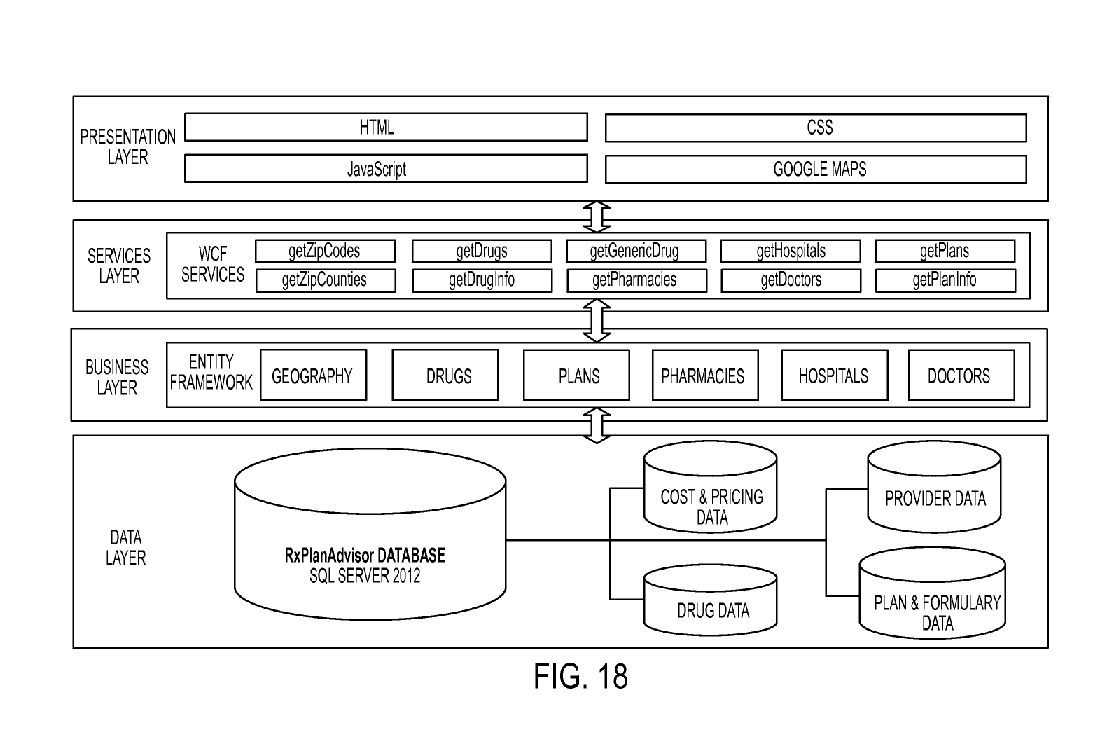

FIG. 18 demonstrates the different architectural layers of the application, including presentation, services, business, and data layers. The presentation layer is primarily based on HTML5, CSS3, and JavaScript technologies. The services layer is implemented using Windows Communication foundation services. The business layer utilizes the Entity Framework for business objects that serve as a representation of the tables within the database. The data layer is composed of a main SQL Server 2012 database, which retrieves its data from disparate data sources.

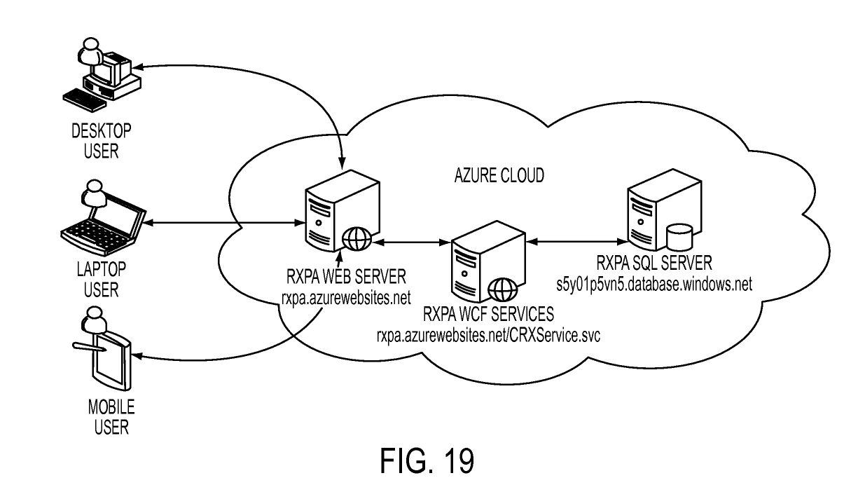

FIG. 19 demonstrates the setup of the servers within the Windows Azure Cloud environment. Users access the application through the web server. The web server contains the web application's presentation layer and fetches data from the services deployed on the services server. The services server contains the Windows Communication Foundation services and retrieves data from the database server. The database server contains an SQL Server 2012 database that stores all of the data utilized by the application.

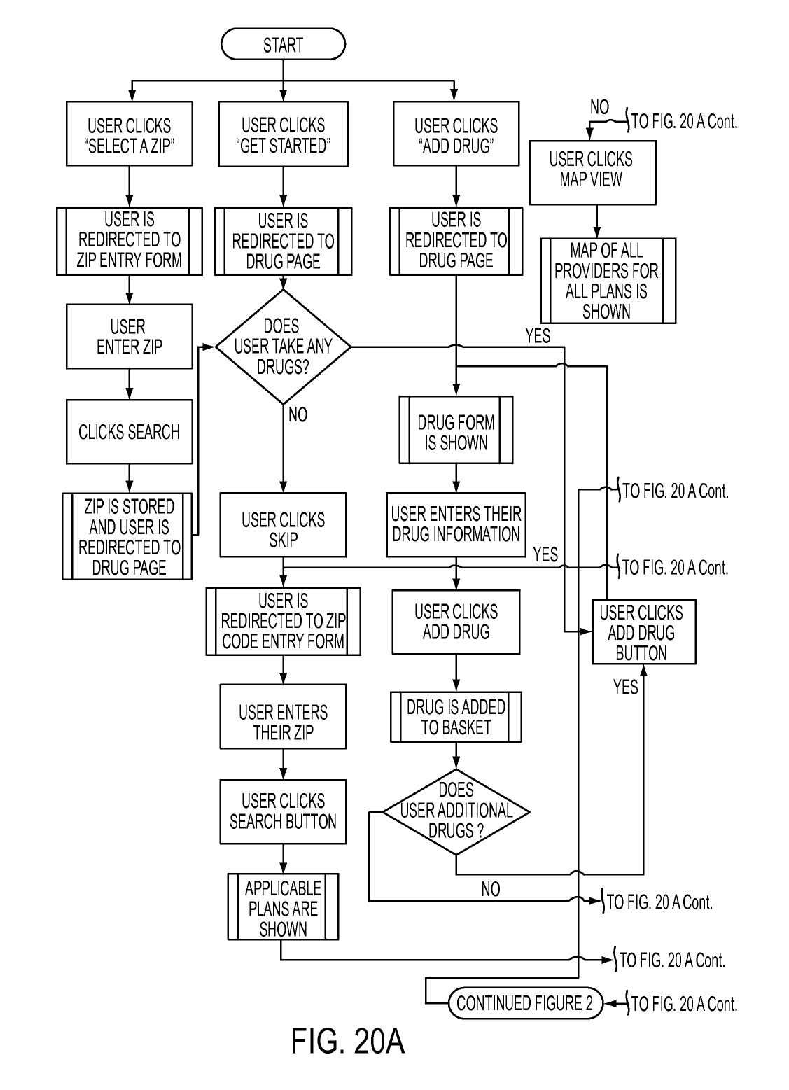

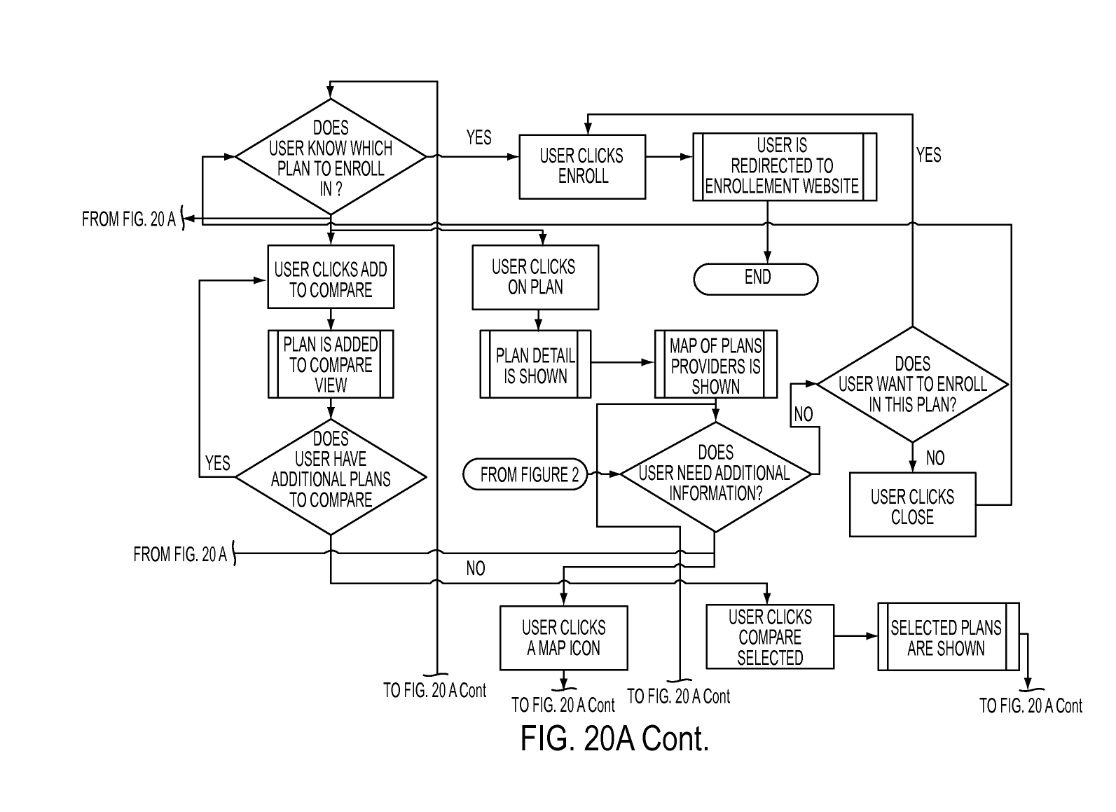

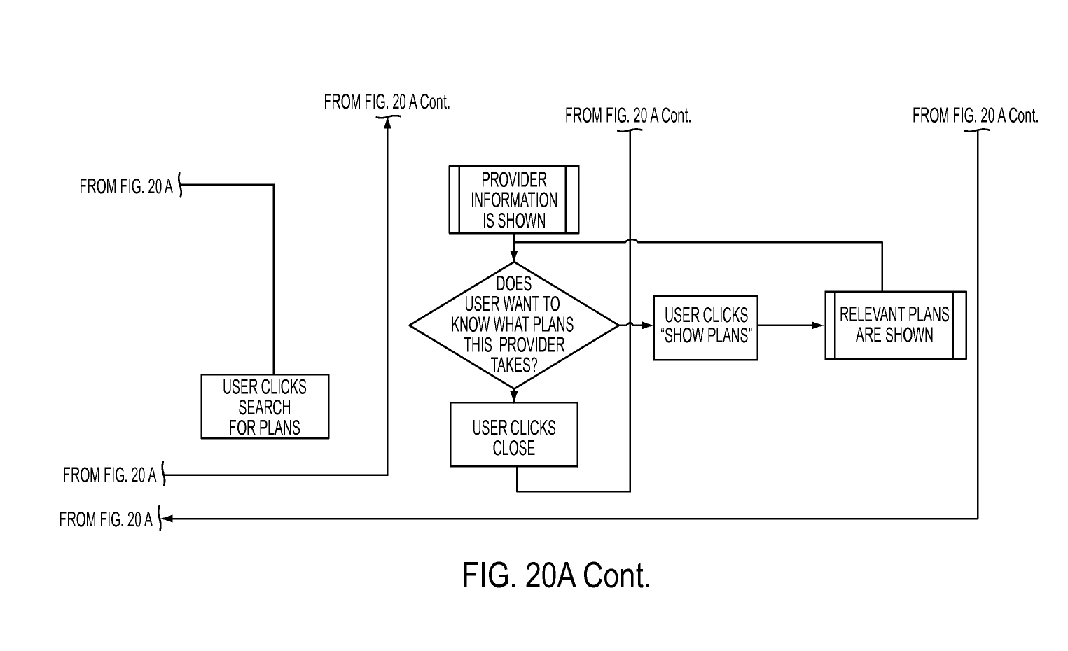

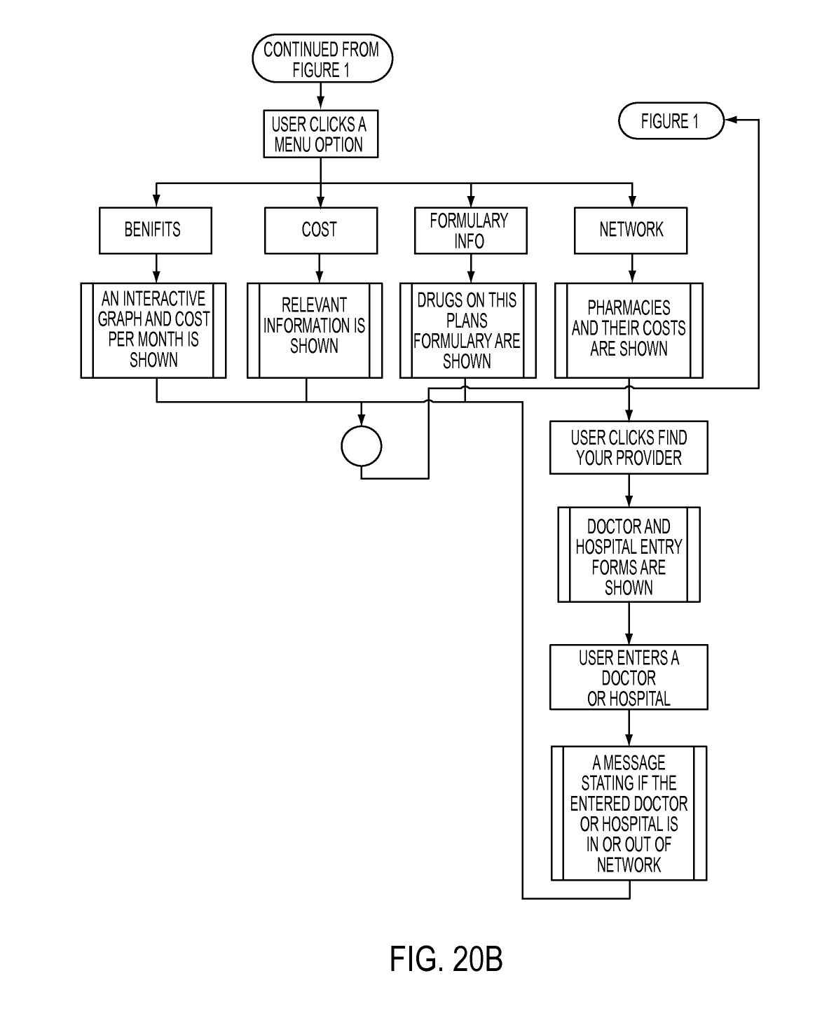

FIGS. 20A and 20B depict the possible actions the user can take to get from opening the web application to enrolling in a plan.

The exemplary systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like.

The systems and methods of the present disclosure may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Although some of the screens illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

Appendix A illustrates exemplary services that could be utilized in the performance of present disclosure.

The services utilized in Appendix A are implemented using Windows Communication Foundation (WCF). The protocol used by the services is JSON. The advantage of using JSON as the protocol over using an XML protocol is that JSON is more compact and can be easily loaded in JavaScript. These services are set up to access the database real-time to retrieve up to the minute data and can be integrated into an application in any manner that is specific for that application. The services are discussed in Appendix A are:
getZipCodes
getZipCounties
getDrugs
getDrugInfo
getDose
getGenericDrug
getPharmacies
getHospitals
getDoctors
getPlans
getPlansNoDrugs
getFormularyInfoByPlan
getPharmacyCosts
getPlanRatings
getPlansByPharmacy
getBenefitsByPlan
getFormularyAlternative

Appendix B is pseudo code for various functions used within the present disclosure. The following Abbreviations are used in the Pseudo Code in Appendix B:
Generic Product Indicator=GPI or GPI14
National Drug Code =NDC
Prescription Drugs=Rx
Over the Counter drugs=OTC

1. A computerized method for calculating and displaying health care plans to a computer user, comprising:
receiving at a server from the computer user prescription data for a plurality of drugs;
receiving at the server from the computer user zip code information;
confirming that the prescription data and the zip code information is correct;
calculating and storing at said server a list of health care plans wherein the health care plans comprise the cheapest plans among all providers in the zip code information;
presenting to the computer user the list of health care plans; and
prompting the user whether they want to enroll in any of the health care plans in the list;

2. The method of claim 1, further comprising:
directing the user, if the user wants to enroll in a selected plan in the list, to the selected plan's website;

3. The method of claim 2, further comprising:
plotting the providers on a map where the user can select a provider and see what plans are associated with the selected provider.

4. The method of claim 3, further comprising:
allowing the user to filter the plotted providers on the map by whether a selected provider is in the user's network.

5. The method of claim 4, further comprising:
displaying an interactive graph per plan showing the net cost of the plan per month per drug selected, wherein each drug's cost is displayed on the interactive graph;

6. The method of claim 4, wherein the calculating and storing the list of health care plans is executed using LINQ queries;

7. The method of claim 5, further comprising:
providing a voice command tool which gives the user the option to interface with the system using their voice;

8. The method of claim 6, wherein the map uses the Google Maps API and the jQuery library.
